(19) United States
(12) Patent Application Publication
(10) Pub. No.: US 2009/0038556 A1
(43) Pub. Date: Feb. 12, 2009

(54) Method For Culturing Benthic Organisms Without Feeding

(75) Inventor: Kazuyuki Ouchi, Nagano (JP)

Correspondence Address: GRIFFIN & SZIPL, PC, SUITE PH-1, 2300 NINTH STREET, SOUTH, ARLINGTON, VA, 22204, US

(73) Assignee: Ouchi Ocean Consultant, Inc., Nagano (JP)

(21) Appl. No.: 11/908,069

(22) PCT Filed: Mar. 8, 2005
(86) PCT No.: PCT/JP2005/004399

§ 371 Date: Feb. 6, 2008

(30) Foreign Application Priority Data
Mar. 8, 2005 (JP) PCT/JP2005/004399

(51) Int. Cl. A01K 61/00

(52) U.S. Cl. 119/207; 47/1.4

(57) ABSTRACT

A method for culturing benthic organisms in a culture pond without feeding uses an apparatus for continuously drawing up bottom layer water and dispersing it into upper layer water. The apparatus is provided for a culture pond of benthic organisms. Organic matter in the bottom layer water is mixed with the upper layer water to be mineralized, thereby raising the density of inorganic nutrient salts, so that photosynthesis in the upper layer water is activated to increase plant plankton.

### TECHNICAL FIELD

The present invention relates to a method for culturing benthic organisms without feeding.

### BACKGROUND ART

One method commonly used nowadays for culturing shrimps in a culture pond formed on land is a high-density culturing method wherein pellets made of animal material are fed to shrimps to harvest 500 g/m² of shrimps every year. In this method, water in the culture pond is circulated along the periphery of the pond to gather sludge composed of exuviae of shrimps, excreta of shrimps, etc. to the center area of the pond, and then divers go under water to dredge the bottom of the center area of the pond, thereby removing the sludge gathered there.

Drawbacks of the high-density culturing method include that the cost of feed puts a burden on producers because it accounts for half of the culturing cost, sludge removed from the culture pond causes environmental problems, etc. On the other hand, a careless culturing method wherein open seawater is let in and out a culture pond to culture shrimps without feeding is very low in harvest and makes the culturing business financially difficult.

### DISCLOSURE OF INVENTION

The present invention was made to solve the aforementioned problems. Therefore, the object of the present invention is to provide a method for culturing shrimps, wherein cost of feed is lower than that of the high-density culturing method, accumulation of sludge is restricted, and harvest is higher than that of the careless culturing method.

Another object of the present invention is to provide a method for culturing benthic organisms other than shrimps, such as shellfishes, squillas, sea slugs, clam worms, etc., wherein cost of feed is low, accumulation of sludge is restricted, and harvest is higher than that of the careless culturing method.

In order to achieve the aforementioned objects, the present invention provides a method for culturing benthic organisms without feeding comprising steps of, providing a culture pond of benthic organisms with an apparatus comprising means for continuously drawing up bottom layer water and means for dispersing the drawn up water into upper layer water, and mixing organic matter in the bottom layer water with the upper layer water to mineralize it, thereby raising the density of inorganic nutrient salts in the upper layer water to activate photosynthesis in the upper layer water, thereby increasing plant plankton in the upper layer water.

Continuous dispersion of bottom layer water into upper layer water causes dispersion of organic matter, such as exuviae of benthic organisms, excreta of benthic organisms, etc., which are suspended in the bottom layer water, into the upper layer water. Aerobic bacteria increase in the upper layer water containing high density dissolved oxygen to decompose the organic matter coming from the bottom of the culture pond into inorganic nutrient salts. The density of inorganic nutrient salts in the upper layer water increases to activate photosynthesis, thereby increasing plant plankton and animal plankton eating plant plankton. Benthic organisms grow and proliferate, supported by the abundant plant plankton and animal plankton available for their consumption.

In accordance with the present invention, cost of feed becomes zero because benthic organisms can be cultured without feeding. In accordance with the present invention, a culture pond for culturing benthic organisms can be continuously used for many years because accumulation of sludge on the bottom of the pond is restricted. Though the method of the present invention results in a harvest poorer than that of the high-density culturing method, it achieves a harvest better than that of the careless culturing method. In accordance with the present invention, wholesome and tasty benthic organisms can be produced because plant plankton and animal plankton like those eaten by natural benthic organisms are consumed by cultured benthic organisms.

In a preferred embodiment of the present invention, the method further comprises a step of fertilizing the bottom of the culture pond with organic matter before starting the culture to supply the upper layer water with inorganic nutrient salts at the beginning stage of the culture of the benthic organisms.

The density of organic matter in the bottom layer water is low at the beginning stage of the culture of the benthic organisms. Fertilizing the bottom of the culture pond with organic matter such as poultry excreta, etc. before the start of the culture can establish a high density of inorganic nutrient salts in the upper layer water to increase plant plankton and animal plankton at the beginning stage of the culture. The fertilization causes only a slight increase of culturing cost because one time fertilization before the start of the culture is usually enough.

In another preferred embodiment of the present invention, the method further comprises a step of fertilizing the bottom of the culture pond with organic matter during the culture.

The bottom of the culture pond can be fertilized with organic matter during the culture when the proliferation of the plant plankton and the animal plankton is insufficient.

In another preferred embodiment of the present invention, the method further comprises a step of continuously exchanging seawater in the culture pond with open seawater using a water exchange pump to keep the temperature and quality of seawater in the culture pond in good condition.

Continuous exchange of seawater in the culture pond with open seawater using a water exchange pump can prevent degradation of the quality of seawater in the culture pond with the passage of time and prevent temperature rise of the seawater in the culture pond with the passage of time.

In another preferred embodiment of the present invention, the method further comprises a step of excavating the bottom of the culture pond below the apparatus to form a bottom layer water reservoir.

Organic matter in the water near the bottom of the culture pond can be made to gather in the bottom layer water reservoir so as to be drawn up efficiently.

### BRIEF DESCRIPTION OF DRAWINGS

FIG. 1 is a structural view of a system for carrying out a method for culturing shrimps without feeding in accordance with a preferred embodiment of the present invention. (a) is a plan view and (b) is a sectional view.

FIG. 2 is a sectional view of a density current dispersion apparatus for carrying out a method for culturing shrimps without feeding in accordance with a preferred embodiment of the present invention.

### BEST MODE FOR CARRYING OUT THE INVENTION

A preferred embodiment, wherein the present invention is used for culturing shrimps, which are kinds of benthic organisms, will be described.

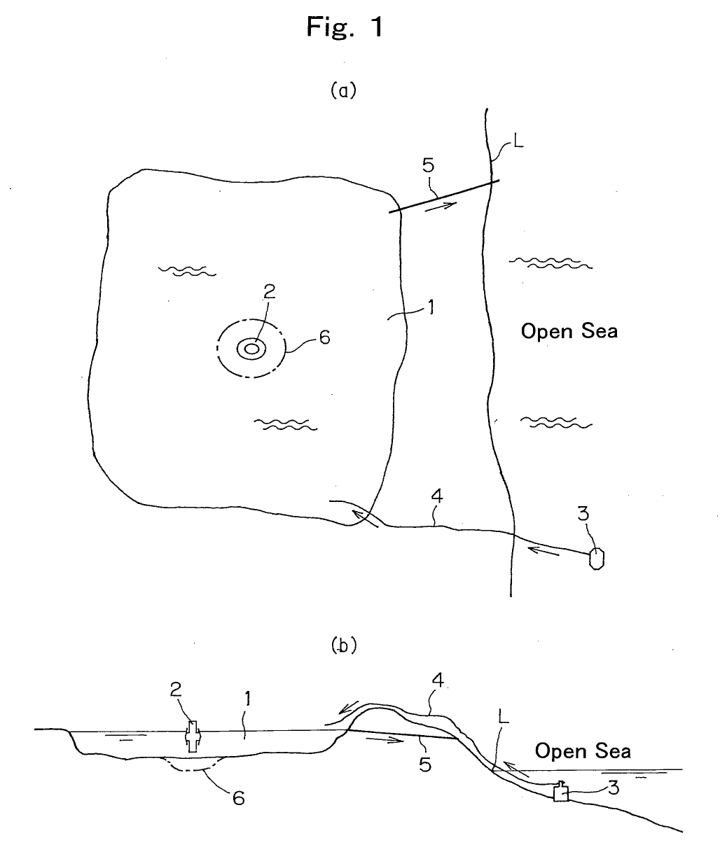

As shown in FIG. 1, a shrimp culture pond 1 is located beside a beach L. The shrimp culture pond 1 is provided with a density current dispersion apparatus 2 at the center portion. A water exchange pump 3 is placed on the sea-bottom near the beach L. An intake pipe 4 extends from the water exchange pump 3 across a bank of the beach to the shrimp culture pond 1. A discharge pipe 5 distanced from the intake pipe 4 extends from the shrimp culture pond 1 to a place near the beach L, penetrating slightly downward through the bank of the beach on the way.

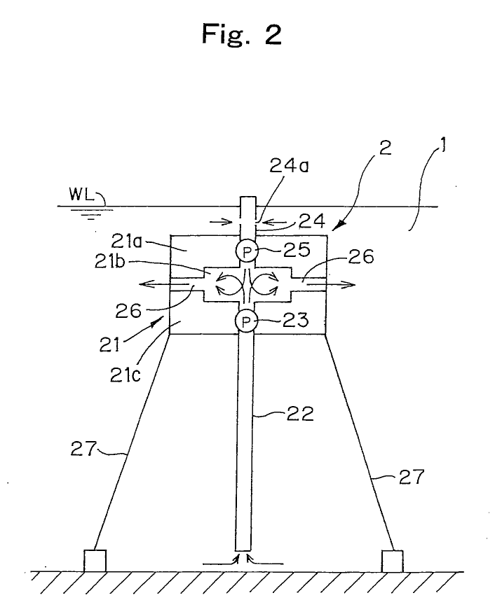

As shown in FIG. 2, the density current dispersion apparatus 2 comprises a floating structure 21 immersed in the water. The floating structure 21 comprises an upper compartment 21a, a middle compartment 21b and a lower compartment 21c.

A bottom layer water intake pipe 22 penetrates the center portion of the lower compartment 21c as seen from above to extend downward vertically. The upper end of the bottom layer water intake pipe 22 communicates with the middle compartment 21b. The lower end of the bottom layer water intake pipe 22 is located near the bottom surface of the shrimp culture pond 1. The bottom layer water intake pipe 22 is provided with a pump 23 at the portion thereof extending through the lower compartment 21c.

An upper layer water intake pipe 24 penetrates the center portion of the upper compartment 21a as seen from above to extend upward vertically beyond the water surface WL of the shrimp culture pond 1. The upper end of the upper layer water intake pipe 24 is closed. The upper layer water intake pipe 24 is provided with a plurality of intake ports 24a at the portion below and near the water surface. The lower end of the upper layer water intake pipe 24 communicates with the middle compartment 21b. The upper layer water intake pipe 24 is provided with a pump 25 at the portion thereof extending through the upper compartment 21a.

A plurality of outlet passages 26 circumferentially distanced from each other extend radially and horizontally from the circumferential wall of the middle compartment 21b. The outlet passages 26 are located at the lower portion of upper layer of seawater in the shrimp culture pond 1.

The density current dispersion apparatus 2 is suspended in the seawater in the shrimp culture pond 1 and is moored at the center portion of the shrimp culture pond 1 with anchor cables 27 provided with anchors.

Electric cables for supplying the pumps 23 and 25 with electric power, which are not shown in Figures, extend from the pumps to an electric power supply located near the shrimp culture pond 1.

A method for culturing shrimps without feeding in accordance a preferred embodiment of the present invention is carried out as follows using the aforementioned equipment.

The pump 23 of the density current dispersion apparatus 2 operates to continuously draw up bottom layer water in the shrimp culture pond 1 through the bottom layer water intake pipe 22, thereby discharging the water in the middle compartment 21b of the floating structure 21. The pump 25 operates to continuously draw upper layer water in the shrimp culture pond 1 through the upper layer water intake pipe 24, thereby discharging the water in the middle compartment 21b of the floating structure 21.

The bottom layer water is mixed with the upper layer water in the middle compartment 21b. The mixed water is discharged through the outlet passages 26 into the lower portion of the upper layer of the seawater in the shrimp culture pond 1. The lower portion of the upper layer of the seawater in the shrimp culture pond 1 has the same temperature as the mixed water. The upper layer water is stratified according to its density. The mixed water penetrates one of the layers of the stratified upper layer water, said one of the layers having the same density as the mixed water, to disperse horizontally to a great distance, while forming a current of seawater with a uniform density distribution, i.e., a density current.

Continuous dispersion of the bottom layer water into the upper layer water causes dispersion of organic matter, such as exuviae of shrimps, excreta of shrimps, etc., which are suspended in the bottom layer water, into the upper layer water. Aerobic bacteria increase in the upper layer water containing high density dissolved oxygen to decompose the organic matter coming from the bottom of the culture pond into inorganic nutrient salts. The density of the inorganic nutrient salts in the upper layer water increases to activate photosynthesis, thereby increasing plant plankton and animal plankton eating plant plankton. Shrimps grow and proliferate, supported by abundant plant plankton and animal plankton available for their consumption. Sludge accumulation on the bottom of the culture pond is restricted because the organic matter in the bottom layer water is transferred to the upper layer water and decomposed there.

In accordance with the present embodiment, cost of feed becomes zero because shrimps can be cultured without feeding. The shrimp culture pond 1 can be continuously used for many years because accumulation of sludge on the bottom of the culture pond is restricted. Though the harvest becomes poorer than that achieved by the high-density culturing method, the harvest becomes better than that achieved by the careless culturing method. Wholesome and tasty shrimps can be produced because plant plankton and animal plankton like those eaten by natural shrimps are consumed by cultured shrimps.

In the present embodiment, the bottom of the shrimp culture pond 1 is fertilized with organic matter, such as poultry excreta, etc., before starting the culture to supply inorganic nutrient salts at the beginning stage of the culture of shrimps.

The density of organic matter in the bottom layer water is low at the beginning stage of the culture of the shrimps because the quantity of exuviae of shrimps, excreta of shrimps, etc., which are suspended in the bottom layer water, is small at the beginning stage of the culture of shrimps. Fertilizing the bottom of the culture pond 1 with organic matter before the start of the culture can establish a high density of organic matter in the bottom layer water and a high density of inorganic nutrient salts in the upper layer water to increase plant plankton and animal plankton at the beginning stage of the culture. The fertilization causes only a slight increase of culturing cost because one time fertilization before the start of the culture is usually enough.

The bottom of the shrimp culture pond 1 can be fertilized with organic matter during the culture when the increase of the plant plankton and the animal plankton is insufficient.

In the present embodiment, the water exchange pump 3 operates to continuously supply the shrimp culture pond 1 with open seawater through intake pipe 4. Surface layer water in the shrimp culture pond 1 is continuously and naturally discharged to the open sea through the discharge pipe 5.

Continuous exchange of seawater in the shrimp culture pond 1 with seawater in the open sea can prevent degradation of the quality of the seawater in the shrimp culture pond 1 with the passage of time and prevent temperature rise of the seawater in the shrimp culture pond 1 with the passage of time.

Instead of continuously exchanging seawater in the shrimp culture pond 1 with seawater in the open sea, it is possible to open and close a floodgate synchronously with ebb and flow of seawater in the open sea, thereby regularly exchanging seawater in the shrimp culture pond 1 with seawater in the open sea.

As indicated by an alternate long and short dash line in FIG. 1, the bottom of the shrimp culture pond below the density current dispersion apparatus 2 can be excavated to form a bottom layer water reservoir 6. Organic matter in the water near the bottom of the culture pond can be made to gather in the bottom layer water reservoir 6 to be drawn up efficiently. When the bottom layer water reservoir 6 is fertilized with organic matter before the start of the culture, the organic matter can be dispersed into the upper layer water efficiently.

The present invention can be used for culturing benthic organisms other than shrimps, such as shellfishes, squillas, sea slugs, clam worms, etc. The harvest becomes better than that achieved by the careless culturing method, while minimizing cost of feed and restricting accumulation of sludge.

### INDUSTRIAL APPLICABILITY

The present invention can be widely used for culturing benthic organisms, such as shrimps, shellfishes, squillas, sea slugs, clam worms, etc.

1. A method for culturing benthic organisms without feeding comprising steps of, providing a culture pond of benthic organisms with an apparatus comprising means for continuously drawing up bottom layer water and means for dispersing the drawn up water into upper layer water, and mixing organic matter in the bottom layer water with the upper layer water to mineralize it, thereby raising the density of inorganic nutrient salts in the upper layer water to activate photosynthesis in the upper layer water, thereby increasing plant plankton in the upper layer water.

2. A method for culturing benthic organisms without feeding of claim 1, further comprising a step of fertilizing the bottom of the culture pond with organic matter before starting the culture to supply the upper layer water with inorganic nutrient salts at the beginning stage of the culture of the benthic organisms.

3. A method for culturing benthic organisms without feeding of claim 1, further comprising a step of fertilizing the bottom of the culture pond with organic matter during the culture.

4. A method for culturing benthic organisms without feeding of claim 1, further comprising a step of continuously exchanging seawater in the culture pond with open seawater using a water exchange pump to keep the temperature and quality of seawater in the culture pond in good condition.

5. A method for culturing benthic organisms without feeding of claim 1, further comprising a step of excavating the bottom of the culture pond below the apparatus to form a bottom layer water reservoir.

6. A method for culturing benthic organisms without feeding of claim 2, further comprising a step of fertilizing the bottom of the culture pond with organic matter during the culture.
